(19) United States
(12) Patent Application Publication
(10) Pub. No.: US 2008/0043702 A1
(43) Pub. Date: Feb. 21, 2008

(54) METHOD AND APPARATUS FOR CELL SEARCH IN A COMMUNICATION SYSTEM

(75) Inventors: Hi-Chan MOON, Yongin-si (KR); Hoon Huh, Seoul (KR); Chae-Man Lim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/840,845

(22) Filed: Aug. 17, 2007

(30) Foreign Application Priority Data
Aug. 17, 2006 (KR) 77890-2006

(51) Int. Cl. H04B 7/216

(52) U.S. Cl. 370/342

(57) ABSTRACT

A cell search using a Primary Synchronization Channel (P-SCH) and an Secondary Synchronization Channel (S-SCH) received from a Base Station (BS) are provided, in which a Mobile Station (MS) receives a P-SCH signal including at least two different P-SCH synchronization codes in different slots of a frame and detects slot timing and frame timing using the P-SCH signal.

### PRIORITY

This application claims the benefit under 35 U.S.C. § 119(a) of a Korean Patent Application filed in the Korean Intellectual Property Office on Aug. 17, 2006 and assigned Serial No. 2006-77890, the entire disclosure of which is incorporated herein by reference.

### BACKGROUND OF THE INVENTION

1. Field of the Invention

The present invention relates to the structures of Synchronization CHannels (SCHs) by which a Mobile Station (MS) acquires time synchronization to a Base Station (BS), and in particular how the MS obtains information about a cell including the BS, and a synchronization method.

2. Description of the Related Art

In a cellular system, an MS accesses a communication network through a BS within a cell where the MS is located. Upon power-on, the MS performs a set of operations for acquiring time synchronization and cell information to communicate with the BS. This is called cell search or initial synchronization. Besides, a cell search for a target cell is also required in the case of inter-cell handover or inter-Radio Access Technology (RAT) handover.

The cellular mobile communication system uses different scrambling codes to distinguish between BSs. The asynchronous Wideband Code Division Multiple Access (WCDMA) system for future-generation mobile communications allocates 512 different scrambling codes to BSs, for BS identification. The MS searches for a BS that transmits the strongest signal by cell search, accesses a network through the BS, and thus conducts voice communications or data communications. If the MS checks the phases of all codes (512 codes in WCDMA) to search for a cell, that is, to detect a BS scrambling code in an asynchronous BS system, the cell search takes a long time. To overcome the inefficiency of this method, the current WCDMA system adopts a multi-step cell search algorithm. For implementing the multi-step cell search algorithm, the 512 cell codes are divided into 64 groups each having 8 cell codes.

FIG. 1 illustrates the structures of Synchronization CHannels (SCHs) used for cell search in the asynchronous WCDMA system.

Referring to FIG. 1, there are two SCHs: a primary SCH (P-SCH) and a secondary SCH (S-SCH). A common pilot channel is used to decide a cell number. The basic transmission/reception unit in the physical layer is a radio frame. One radio frame is composed of 15 slots 107, SLOT #0 to SLOT #14, each slot having a length (T_{SLOT}) of 2560 chips. In the asynchronous WCDMA system, the duration of one frame (T_{FRAME}) is 10 ms, equal to one period of a scrambling code or Pseudo Noise (PN) sequence for a downlink channel.

A BS transmits the P-SCH and the S-SCH, 256 chips at the start of every slot. Since the two SCHs carry mutually orthogonal codes, they can be transmitted overlapped. The P-SCH carries a 256-chip Primary Synchronization Code (PSC) 104, Cp. The PSC is common to all cells and an MS detects a slot timing using a matched filter corresponding to the known PSC. The S-SCH is a code sequence with 15 Secondary Synchronization Codes (SSCs) 105, Cₛ. The SSC sequence represents the group number of the scrambling code of a BS. Scrambling codes with different group numbers are allocated to neighbor BSs. Each SSC is 256 chips in length and is one of 16 possible different codes. The MS acquires the frame timing of the BS as well as the group number of the scrambling code of the BS using the S-SCH.

FIG. 2 is a circuit diagram for generating SCHs in the BS.

Referring to FIG. 2, a Serial-to-Parallel (S/P) converter 211 (221, 231) converts a common pilot channel signal to parallel common pilot channel signals and converts them to I-channel data and Q-channel data. Multipliers 212 and 213 spread the I-channel and Q-channel common pilot data with a channel spreading code C_{CH}. A phase shifter 214 (224, 234) shifts the phase of the Q-channel spread data by 90 degrees. An adder 215 (225, 235) generates a complex signal I+jQ by adding the outputs of the multiplier 212 (213, 222, 223, 232, 233) and the phase shifter 214 (224, 234).

In addition to the common pilot channel, the P-SCH, the S-SCH, and other common channels or dedicated channels can further be transmitted. Thus, downlink channel transmitters can further be provided to transmit the common channels or dedicated channels.

A gain controller 200 generates gain control signals for controlling the transmit power and continuation or discontinuation of the common pilot channel, the P-SCH, and the S-SCH.

An adder 260 adds the channel signals whose gains are adjusted by gain adjusters 216, 226 and 236. Baseband filters 261 and 271 filter baseband signals in the sum received from adder 260. Multipliers 262 and 264 multiply the outputs of baseband filters 261 and 271 by carriers. An adder 265 adds the outputs of multipliers 262 and 264 and outputs the sum through an antenna.

FIG. 3 illustrates a cell search process in the WCDMA system.

The MS acquires a downlink scrambling code and the frame timing of a cell by the cell search. In a first step 301, the MS acquires slot synchronization to the cell using a P-SCH signal. The MS acquires frame timing and detects the group number of the scrambling code of the cell by comparing a received S-SCH signal with all possible SSC sequences in a second step 302. The S-SCH signal is encoded and transmitted at the boundary of a frame every 10 ms. A receiver attempts to demodulate the S-SCH signal and determines the timing of a successful demodulated S-SCH signal to be the frame boundary. In a third step 303, the scrambling code of the cell is accurately detected by correlating, on a symbol-by-symbol basis, a received common pilot channel with all codes in the group whose number was detected in the second step. Once the scrambling code is detected, Broadcast CHannel (BCH) information associated with the system or the cell can be obtained by detecting a Primary Common Control Physical CHannel (P-CCPCH).

One S-SCH codeword, which is composed of 15 SSCs, represents one of 64 cell group numbers. Each SSC is one of 16 possible 256-chip codes and thus 16¹⁵ code sequences can be represented by S-SCH codewords. Therefore, 64 codewords can be easily made comma free codes. Since the minimum Hamming distance between two cyclically shifted S-SCH codewords is 14 in the WCDMA system, only two SSCs in two slots suffice for decoding an S-SCH codeword. In this manner, the group number of a scrambling code and frame timing can be detected.

Considering system performance, however, an entire codeword over a radio frame is generally decoded to thereby detect the group number of a scrambling code and acquire frame timing. For this purpose, a received S-SCH codeword is compared with the 64 codewords and their cyclically shifted codewords, i.e. a total of 64×15 codewords, and 64×15×15 SSC correlations are carried out. Since the MS knows only the slot timing through the slot synchronization of the first step, it has to demodulate the comma free code in every slot.

As described above, the cell search is performed in three steps in the WCDMA system. The first and second steps are performed just to acquire frame synchronization and identify the group of a scrambling code. A relatively long iterative SSC correlation operation increases the time delay and implementation complexity.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide an efficient initial synchronization method in a wireless communication system, especially an Orthogonal Frequency Division Multiplexing (OFDM) communication system.

Another aspect of the present invention provides a method for acquiring synchronization with decreased downlink overhead.

A further aspect of the present invention provides a method for initially acquiring frame timing and the group number of a cell through a simple reception process in an MS.

Still another aspect of the present invention provides a method for controlling the time taken for synchronization according to channel environment in an MS.

Yet another aspect of the present invention provides a method for acquiring slot synchronization and frame synchronization using a P-SCH.

In accordance with an aspect of the present invention, there is provided a method for performing a cell search using a P-SCH and an S-SCH received from a BS in an MS, wherein the MS receives a P-SCH signal including at least two different P-SCH synchronization codes in different slots of a frame and detects slot timing and frame timing using the P-SCH signal.

In accordance with another aspect of the present invention, there is provided an apparatus for performing a cell search using a P-SCH and an S-SCH received from a BS in an MS, in which an SCH receiver receives a P-SCH signal including at least two different P-SCH synchronization codes in different slots of a frame, and a synchronization detector, which detects slot timing and frame timing using the P-SCH signal.

### BRIEF DESCRIPTION OF THE DRAWINGS

The above and other objects, features and advantages of certain exemplary embodiments of the present invention will be more apparent from the following detailed description taken in conjunction with the accompanying drawings, in which:

FIG. 1 illustrates the structures of Synchronization CHannels (SCHs) used for cell search in an asynchronous WCDMA system;

FIG. 2 is a circuit diagram for generating SCHs in a BS;

FIG. 3 illustrates a cell search process in the WCDMA system;

FIG. 4 illustrates a cell search process according to the present invention;

FIGS. 5A, 5B and 5C illustrate structures of a P-SCH according to the present invention;

FIGS. 6A, 6B and 6C illustrate S-SCH transmission schemes according to the present invention;

FIGS. 7A, 7B and 7C illustrate structures of an S-SCH in one frame according to the present invention;

FIG. 8A is a block diagram of an MS receiver for receiving the S-SCH according to the present invention;

FIG. 8B is a block diagram of a BS transmitter for transmitting the S-SCH according to the present invention;

FIG. 9 is a block diagram of a cell search apparatus in an MS according to the present invention;

FIG. 10 is a block diagram of a cell search apparatus in an MS according to the present invention;

FIG. 11 is a block diagram of a cell search apparatus in an MS according to the present invention;

FIG. 12 is a flowchart illustrating a cell search operation in the MS according to the present invention;

FIG. 13 illustrates a Primary Code (PC) of the P-SCH, having repeated PSCs in time according to the present invention;

FIG. 14 is a block diagram of a cell search apparatus in an MS according to the present invention;

FIG. 15 is a block diagram of a cell search apparatus in an MS according to the present invention;

FIG. 16 is a block diagram of a cell search apparatus in an MS according to the present invention;

FIG. 17 is a flowchart illustrating a cell search operation of the MS according to the present invention;

FIG. 18 illustrates a cell search process according to the present invention; and

FIG. 19 illustrates an application of the present invention to 3^{rd} Generation Partnership Project (3PP) Long-Term Evolution (LTE).

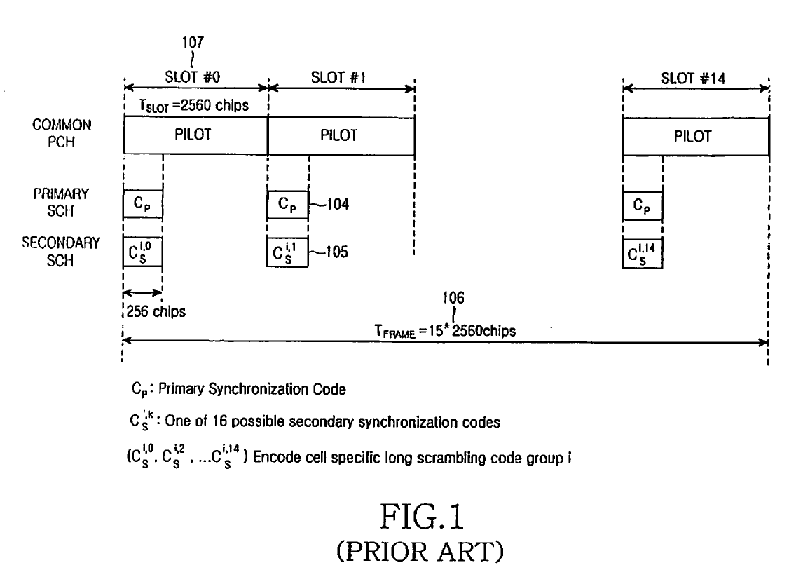

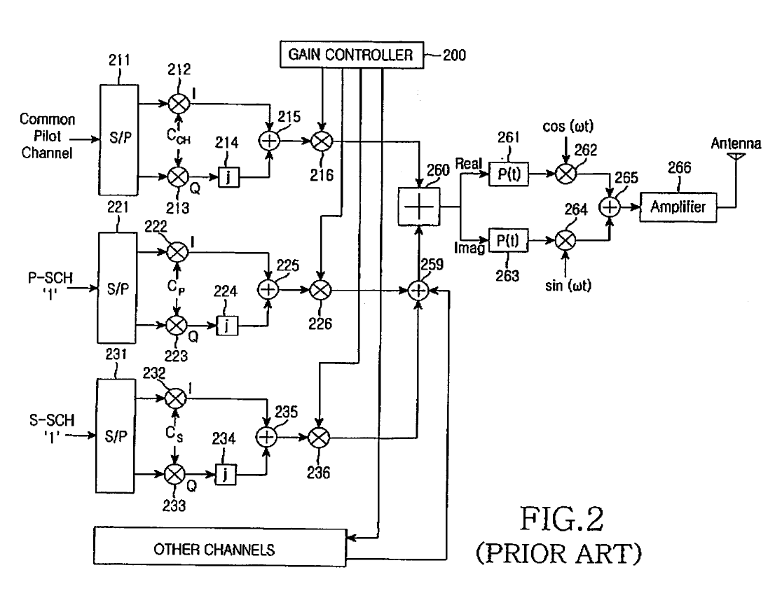

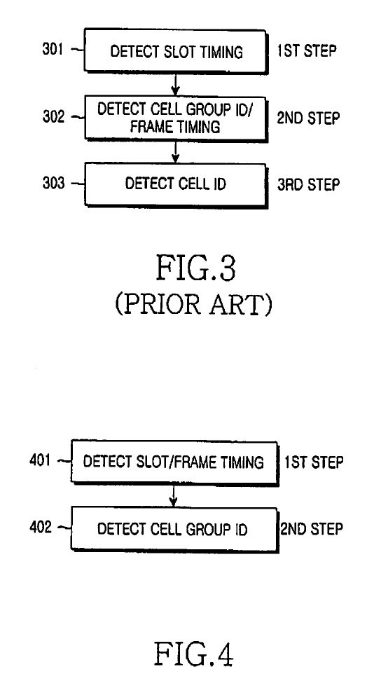

### DETAILED DESCRIPTION OF PREFERRED EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In accordance with the present invention, slot timing and frame timing are acquired using a P-SCH and a cell ID or the group ID of a cell is carried on an S-SCH. If a cell group includes only one cell, the ID of the group is the number of the cell. Therefore, cell ID detection is equivalent to group ID detection.

Referring to FIG. 4, the cell search process involves a first step for simultaneously acquiring slot timing and frame timing using a P-SCH and a second step for detecting the group ID of a cell using an S-SCH.

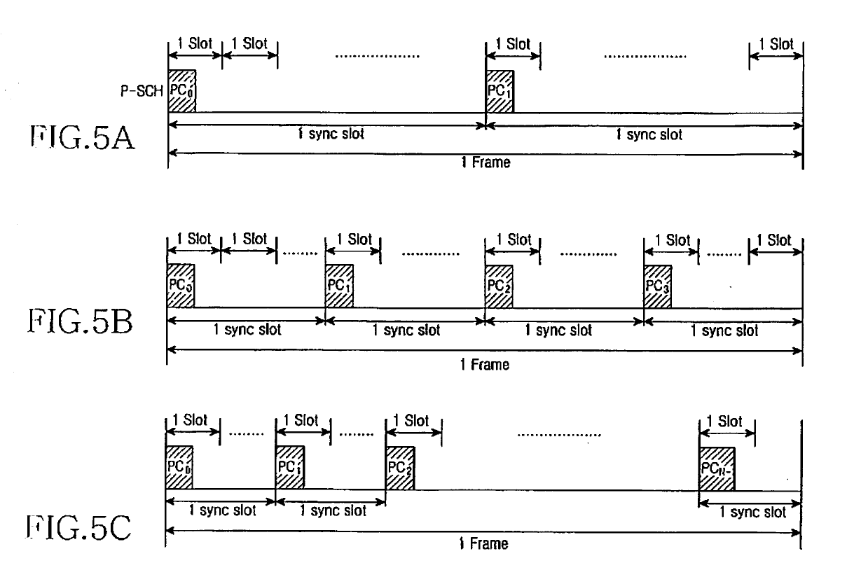

Referring to FIGS. 5A, 5B and 5C, a frame is a basic time unit in the physical layer. In WCDMA, one frame is 10 ms in duration, equal to the period of a scrambling code and is composed of 15 slots. Power control is performed on a slot basis. In 3GPP LTE, one frame is 10 ms in duration and includes 20 subframes. A subframe is a basic data transmission unit.

The frame can be as long as the period of a scrambling code for a downlink channel or the frame length can be an integer multiple of the period of the scrambling code. In this case, once the timing of the frame is known, the start of the scrambling code can be detected. Also, the period of the scrambling code can be an integer multiple of the frame length. In this case, after acquiring frame timing, an MS needs to estimate the start of the scrambling code or to receive information required for the estimation. This operation is beyond the scope of the present invention, and thus its description is not provided herein.

In accordance with an exemplary embodiment of the present invention, the P-SCH is composed of two or more PCs, generally N PCs. The interval between two adjacent PCs is called a sync slot. Different PCs are carried in different slots. Each PC indicates the slot position of the P-SCH signal in a frame. One PC occupies one OFDM symbol. While the P-SCH may be transmitted over an entire frequency band, it can occupy part of the frequency band considering downlink overhead. It is assumed herein that the P-SCH is carried in a bandwidth of 1.25 MHz.

As more PCs are carried in one frame, the performance of slot synchronization and frame synchronization is increased through combining. However, since the PCs impose overhead, the length of a P-SCH codeword including PCs should be decided, taking into account both performance and overhead.

Referring to FIG. 5C, N PCs, PC₀ to PC_{N-1} form one P-SCH codeword and each PC, PCₖ is a different code. A requirement of the PCs is that they have good correlation characteristics. The PCs can be orthogonal codes. In an exemplary embodiment of the present invention, Walsh codes or a Generalized Chirp Like (GLC) sequence can be used as the PCs.

For two sync slots, N possible code sequences can be considered at a receiver, (PC₀, PC₁), (PC₁, PC₂), . . . , (PC_{N-1}, PC_{N}). For three sync slots, the number of possible code sequences is also N, (PC₀, PC₁, PC₂), (PC₁, PC₂, PC₃), . . . , (PC_{N-1}, PC_{N}, PC₁). In the same manner, N code sequences can be considered for any of 3 to N slots.

Therefore, the receiver estimates one of N code sequences for a predetermined number of sync slots of the P-SCH and acquires frame timing using the estimated code sequence.

As described above, the receiver can simultaneously acquire slot timing and frame timing using the P-SCH. Thereafter, it estimates a cell ID. For this purpose, the BS transmits information about the cell ID on an S-SCH.

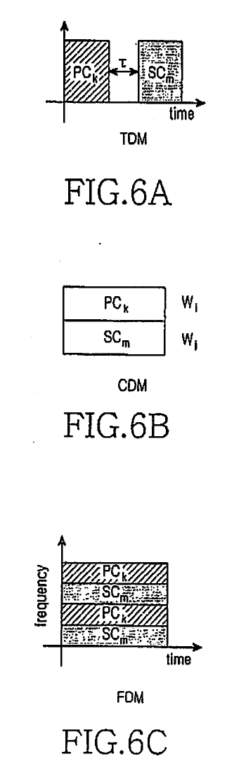

In FIGS. 6A, 6B and 6C, PCₖ and SCₘ denote a PC of the P-SCH and a Secondary Code (SC) of the S-SCH. Referring to FIG. 6A, PCₖ and SCₘ are transmitted in different time slots at an interval τ. If τ=0, PCₖ and SCₘ are successive. Referring to FIG. 6B, PCₖ and SCₘ are transmitted simultaneously using orthogonal codes in Code Division Multiplexing (CDM), as with Code Division Multiple Access (CDMA). The P-SCH and the S-SCH can be designed so as to be mutually orthogonal. Referring to FIG. 6C, PCₖ and SCₘ are transmitted in different frequencies in Frequency Division Multiplexing (FDM). OFDM is also applicable to the transmission of the P-SCH and the S-SCH. In the illustrated case of FIG. 6C, the P-SCH is confined to even-numbered frequency bands and the S-SCH to odd-numbered frequency bands on the frequency axis.

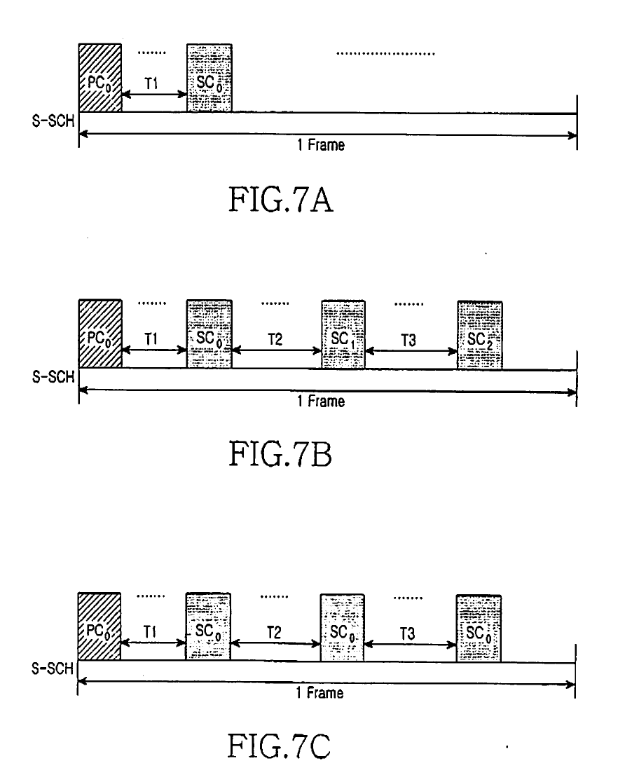

Referring to FIGS. 7A, 7B and 7C, while one PC is transmitted in one frame, it is just for illustrative purposes of showing transmission of the P-SCH and the S-SCH together. In real implementation, a plurality of PCs are transmitted in one frame. As illustrated in FIGS. 6A, 6B and 6C, CDM, FDM and TDM are available for transmitting the P-SCH and the S-SCH, although the P-SCH and the S-SCH are shown to be transmitted in TDM in FIGS. 7A, 7B and 7C. Time intervals between synchronization codes, T1, T2 and T3 are determined freely.

Referring to FIG. 7A, one SC carries all information that the S-SCH is supposed to deliver in one frame. The S-SCH is transmitted time T₁ after a PC. T1 is preset between an MS and a BS. The reason for transmitting all the information in one SC is that as the MS acquires frame timing using the P-SCH, it can accurately locate the S-SCH.

However, it may occur that all the S-SCH information cannot be delivered in one SC or a long time is taken to receive the S-SCH if the position of the SC is exposed to a poor channel environment. Therefore, the S-SCH is distributed across one frame as illustrated in FIGS. 7B and 7C.

Referring to FIG. 7C, the S-SCH information is encoded, spread with a spreading code, segmented into a plurality of small blocks, and distributed across one frame. In this case, while the MS has to receive a plurality of SCs in the frame in order to detect a cell ID using the S-SCH, the distributed transmission of the SCs reduces performance degradation caused by a fading channel.

Referring to FIG. 7C, the S-SCH carries all the S-SCH information in one SC like the S-SCH transmission scheme illustrated in FIG. 7A, but the one SC is mapped repeatedly to a smaller block, compared to the SC blocks illustrated in FIG. 7B. That is, S-SCH information encoded to a small size occurs repeatedly in one frame. In the illustrated case of FIG. 7C, an SC carrying the group ID of a cell, SC₀ is repeatedly transmitted in one frame.

Meanwhile, as the MS has already acquired frame timing using the P-SCH, it can demodulate the group ID using any SC received in a frame. In a good channel state, the MS detects the group ID by receiving any SC. That is, if the Signal-to-Noise Ratio (SNR) or reception level of the received S-SCH is sufficiently high due to the good channel status, the MS can end the group ID acquisition operation even by receiving one SC. On the other hand, if the signal level of a received SC is not sufficient, the MS can combine a plurality of SCs of the S-SCH to thereby increase reception performance.

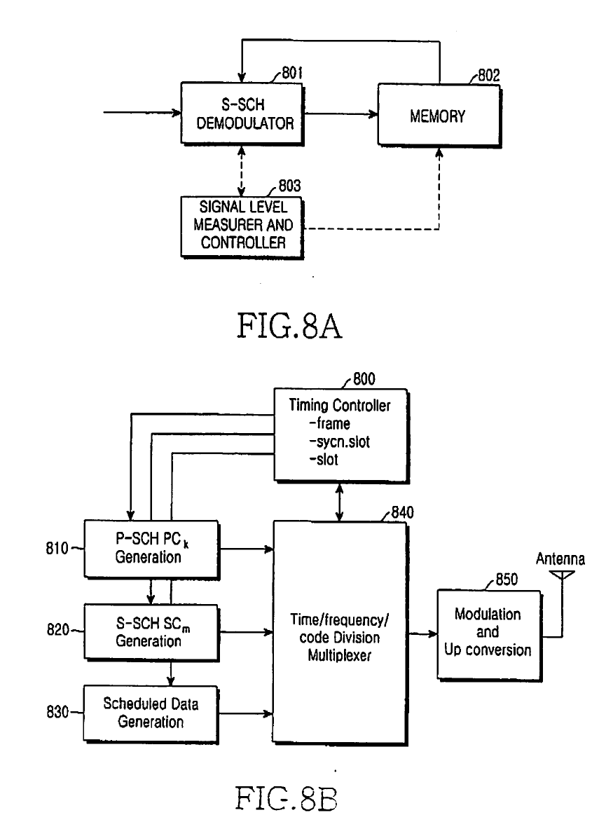

Referring to FIG. 8A, an S-SCH demodulator 801 extracts demodulated information of an S-SCH including a group ID from a received SC and a memory 802 stores the demodulated S-SCH information. S-SCH demodulator 801 operates on a slot basis.

During the demodulation, a signal level measurer and controller 803 measures the signal level of the received SC and determines whether the signal level measurement is sufficiently reliable. If determining that the signal level measurement is sufficiently reliable, the signal level measurer and controller 803 declares that the S-SCH reception is completed. If determining that the signal level measurement is not sufficiently reliable, the signal level measurer and controller 803 controls the S-SCH demodulator 801 to combine the current received SC with an SC received in the next sync slot.

Since it is assumed that the S-SCH occurs repeatedly on a slot basis in the exemplary embodiment of the present invention, S-SCH demodulator 801 demodulates on a slot basis. The number of slots from which the S-SCH is demodulated is variable depending on the reliability of the received S-SCH signal. Alternatively, a predetermined number of slots of the S-SCH can be demodulated according to an already measured signal level, for example, the reception level of the P-SCH.

While it is assumed herein that the transmission period of the S-SCH is equal to that of the P-SCH. However, since the MS has already acquired frame synchronization using the P-SCH, the transmission periods of the P-SCH and the S-SCH may not be always equal. For instance, if four PCs of the P-SCH are transmitted in one frame (i.e. four sync slots are defined in one frame), two SCs of the S-SCH can be transmitted in one frame. In this case, S-SCH demodulator 801 operates according to the transmission period of the S-SCH, not on a slot basis.

As described with reference to FIG. 5A to FIG. 7C, the P-SCH and the S-SCH are transmitted in one of TDM, CDM, and FDM. The transmission of the SCHs is performed in time division with general data on a slot basis or on a sync slot basis. If the SCHs occupy part of a total frequency band, they are transmitted in frequency division or time division with respect to other frequency channels. For example, when an SCH signal occupies 1.25 MHz in a total frequency band of 10 MHz, the SCH signal is transmitted in frequency division with respect to other frequency channels.

Referring to FIG. 8B, a timing controller 800 generates transmission timing signals. Specifically, it generates a frame synchronization signal, a slot (or subframe) synchronization signal, and a sync slot synchronization signal. According to these signals, a PC generator 810, an SC generator 820, and a scheduled data generator 830 generate PCₖ, SCₘ, and general data. A Multiplexer (MUX) 840 multiplexes PCₖ and SCₘ in TDM, CDM or FDM and multiplexes the SCHs with the general data in time division. A modulator and upconverter 850 modulates the multiplexed signal, upconverts the modulated data to a carrier frequency band, and transmits the upconverted signal through an antenna.

Meanwhile, the BS transmits a P-SCH with N code symbols PC₀ to PC_{N-1} in one frame with N sync slots. Each code symbol is transmitted at a predetermined timing in a sync slot. Every BS transmits the common P-SCH PC₀ to PC_{N-1} in the sync slots in the manner illustrated in FIG. 8B.

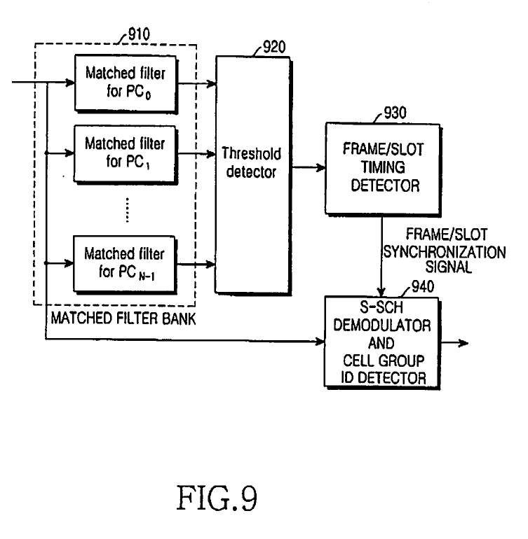

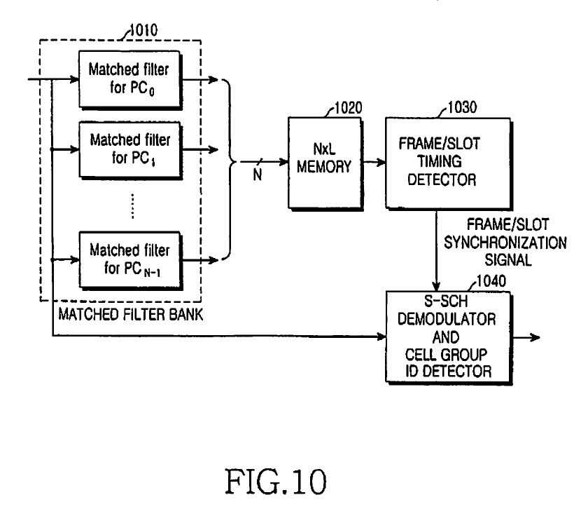

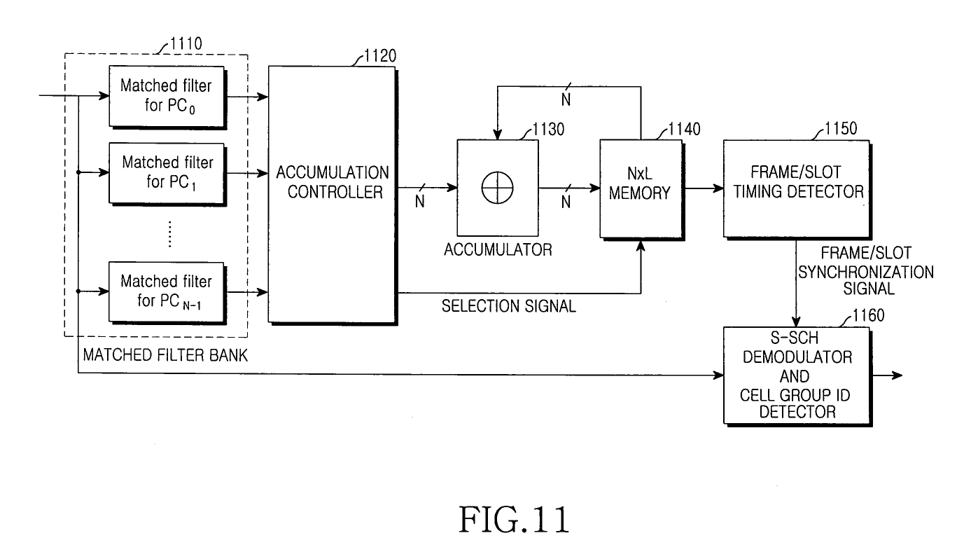

With reference to FIGS. 9, 10 and 11, the MSs illustrated in FIGS. 9 and 10 detect timing using the outputs of a matched filter bank for one sync slot, while the MS illustrated in FIG. 11 detects timing using the outputs of a matched filter bank for an entire radio frame.

With reference to FIG. 9, a cell search method according to an exemplary embodiment of the present invention will first be described. The MS includes N matched filters corresponding to N PCs of the P-SCH. The N matched filters collectively form a matched filter bank 910. The MS can acquire slot timing and frame timing simultaneously by a cell search only for one sync slot, starting at a given time point where the number of samples per sync slot is denoted by L.

A threshold detector 920 compares the outputs of the matched filter bank 910 with a predetermined threshold and detects outputs of the matched filter bank 910 exceeding the threshold.

A frame/slot timing detector 930 determines the timing corresponding to the outputs of matched filter bank 910 exceeding the threshold of the slot timing and detects frame timing using a code symbol mapped to a matched filter corresponding to the slot timing. If there is no matched filter bank output exceeding the threshold, the above operation is repeated for the L samples of another sync slot. Frame/slot timing detector 930 detects the P-SCH using the output of threshold detector 920 and detects the position of the S-SCH using the detected P-SCH signal, as described above.

An S-SCH demodulator and cell group ID detector 940 detects a cell ID by demodulating the S-SCH at the detected position, thus completing the cell search.

The MS illustrated in FIG. 9 is easily configured and requires no additional memory. However, wrong slot/frame synchronization or no synchronization may be acquired according to the threshold. Hence, setting an appropriate threshold is significant.

With reference to FIG. 10, a cell search method according to another exemplary embodiment of the present invention will be described.

Referring to FIG. 10, the MS includes N matched filters corresponding N PCs of the P-SCH. The N matched filters collectively form a matched filter bank 1010. A received signal passes through the matched filter bank 1010, is sampled and is stored in a memory 1020. The MS can acquire slot timing and frame timing simultaneously by a cell search only for one sync slot, starting at a given time point. The outputs of the matched filters for one sync slot are sequentially stored in memory 1020

The number of the samples of one sync slot is denoted by L. Then, the outputs of all matched filters for one sync slot form an N×L matrix. The row and column of an element with a maximum value in the matrix represent the number of a PC and the start of a slot within a window of a size equal to a sync slot, respectively.

A frame/slot timing detector 1030 detects the P-SCH using a signal received from memory 1020 and determines the position of the S-SCH using the detected P-SCH signal. An S-SCH demodulator and cell group ID detector 1040 detects a cell ID by demodulating the S-SCH at the detected position, thus completing the cell search.

The MS illustrated in FIG. 10 is easily configured and does not need to accumulate the outputs of the matched filters through an accumulation controller.

With reference to FIG. 11, a cell search method according to a third exemplary embodiment of the present invention will be described. The MS includes N matched filters corresponding N PCs of the P-SCH. The N matched filters collectively form a matched filter bank 1110. A received signal passes through the matched filter bank 1110, is sampled and is stored in a memory 1140.

An accumulation controller 1120 controls an accumulator 1130 to accumulate outputs of the matched filters at positions of memory 1140 indicated by a selection signal. In accordance with the third exemplary embodiment of the present invention, it is assumed that the outputs of the matched filters are asynchronously accumulated for K sync slots.

The MS can acquire slot timing and frame timing simultaneously by a cell search only for one sync slot, starting at a given time point. The outputs of the matched filters for one sync slot are sequentially stored in memory 1140. The number of the samples of one sync slot are denoted by L. Hence, the outputs of all matched filters for one sync slot form an N×L matrix. The row and column of an element with a maximum value in the matrix represent the number of a PC and the start of a slot within a window of a size equal to a sync slot, respectively.

However, considering channel status such as a fading channel, one sync slot does not suffice for detecting slot timing. Therefore, the outputs of the matched filters for a plurality of sync slots are accumulated. That is, accumulator 1130 accumulates the outputs of the matched filters for the sync slots and stores the accumulation values in memory 1140. Initial values in memory 1140 are set to 0s. Accumulation controller 1120 controls accumulator 1130 and storage 1140 to accumulate the outputs of the matched filters at the same phase.

Accumulator 1130 selects synchronous or asynchronous accumulation according to channel status. In the third exemplary embodiment of the present invention, the outputs of the matched filters are measured and asynchronously accumulated at an interval of one sync slot. When the outputs of the matched filters are accumulated for a plurality of sync slots, a cell search starts at an arbitrary time point. Thus, the start of the search corresponds to the transmission slot timing of an i^{th} PC of the P-SCH among N sync slots carrying N PCs of the P-SCH. Therefore, the output of an i^{th} matched filter is stored and the output of an ((i+1) mod N)^{th} matched filter is accumulated on the output of the i^{th} matched filter. That is, the codeword transmission pattern (0, 1, . . . , N−1) should be considered.

To be more specific about the operation of memory 1140, since every BS transmits the same codeword (PC₀, PC₁, . . . , PC_{N-1}), all possible codewords receivable at the MS are N codewords, (PC₀, PC₁, . . . , PC_{N}), (PC₂, PC₁, . . . , PC₀), . . . , (PC_{N-1}, PC₀, . . . , PC_{N-2}). Assuming that the outputs of the matched filters for a first sync slot are stored in the form of an N×L matrix in memory 1140, the output of a matched filter corresponding to PC₀ is in the first row, the output of a matched filter corresponding to PC₁ is in the second row, and the output of a matched filter corresponding to PC_{N-1} is in the N^{th} row. For a second sync slot, the output of the matched filter corresponding to PC₁ is accumulated in the first row, the output of the matched filter corresponding to PC₂ is in the second row, and the output of a matched filter corresponding to PC_{N} is in the N^{th} row. In this manner, each time the number of a sync slot increases, the number of a matched filter whose output is accumulated at a row of the matrix is shifted. After the accumulation for a predetermined number of sync slots is completed, the accumulation values are stored in memory 1140. A P-SCH codeword and its timing are acquired using the row and column of an element with a maximum value in the N×L matrix stored in memory 1140, and framing synchronization is acquired using the P-SCH codeword and its timing. This operation takes place in a frame and slot timing detector 1150.

The elements W_{i,j} of the N×L matrix are expressed as Equation (1);

$${W}_{i , j} = {\sum }_{p = 0}^{M - 1} {h}_{( p + t - 1 ) modN} ( p \cdot L + j - 1 ) , 1 \leq i \leq N , 1 \leq j \leq L$$

where N denotes the number of PCs per radio frame, L denotes the number of the outputs of a matched filter for one sync slot, M denotes the number of sync slots for which matched filter outputs are accumulated, hₓ(y) denotes an y^{th} sample of a matched filter corresponding to PCₓ.

After the acquisition of slot synchronization and frame synchronization, frame and slot timing detector 1150 provides a slot synchronization signal and a frame synchronization signal to an S-SCH demodulator and cell group ID detector 1160. The S-SCH demodulator and cell group ID detector 1160 detect the position of the S-SCH in the received signal using the slot synchronization signal and the frame synchronization signal. The position of the S-SCH is detected using a predetermined timing in the case of TDM and using a predetermined frequency band in the case of FDM. In the case of CDM, the S-SCH and the P-SCH are at the same position and an SC of the S-SCH is detected using a predetermined code. The S-SCH demodulator and cell group ID detector 1160 acquire a cell ID by decoding the S-SCH.

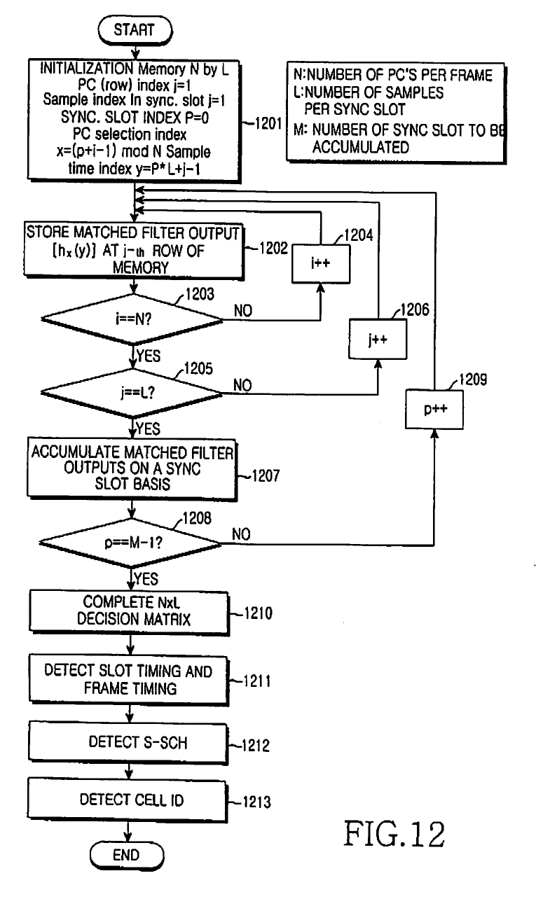

Referring to FIG. 12, an initial value is set in each block in step 1201 and the output of a matched filter is stored in the memory in step 1202. In step 1203, the index i of a PC is compared with the number N of PCs per frame. After increasing i sequentially up to N in step 1204, step 1202 is repeated.

In step 1205, the index j of a sample in the sync slot is compared with the number L of samples per sync slot. After sequentially increasing j up to L in step 1206, steps 1202 and 1203 are repeated.

If j is equal to L in step 1205, the outputs of the matched slots are accumulated on a sync slot basis in step 1207 and then the index p of a sync slot is compared with the number M of sync slots to be accumulated in step 1208.

Until p is equal to (M−1), after increasing p sequentially in step 1209, steps 1202, 1203, 1205, and 1207 are repeated.

If p is equal to (M−1) in step 1208, an N×L decision matrix is completed in step 1210 and slot timing and frame timing are detected in step 1211. The S-SCH is detected in step 1212 and a cell ID is detected in step 1213. Thus the cell search is finished.

The cell search methods using a matched filter bank illustrated in FIGS. 10 and 11 require an N×L memory. The MS having the configuration illustrated in FIG. 11 suffers from high implementation complexity because the accumulation controller should control the output paths of the matched filters. The use of a matched filter bank is common to the MS configurations illustrated in FIGS. 9, 10 and 11. The matched filters are relatively complex in configuration and when a channel has a high Doppler effect, the matched filters have to be divided for asynchronous accumulation in order to eliminate the influence of frequency offsets.

To avert this problem, it can be further contemplated as another exemplary embodiment of the present invention that a PC is delivered by repeating the same signal in time. To do so, the BS operates as described with reference to FIG. 8B except that PC generator 810 generates PCₖ so that it has repeated codes in time.

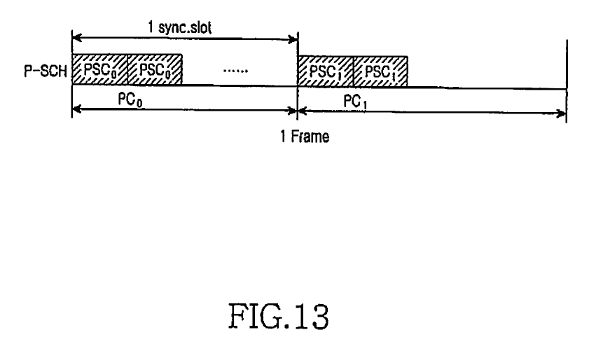

Referring to FIG. 13, a PC, PCᵢ carries the same signal PSCᵢ repeatedly in time so that slot timing can be detected using a differential correlator.

As with matched filters, a receiver configuration using a differential correlator depends on whether a memory and accumulator are used or not.

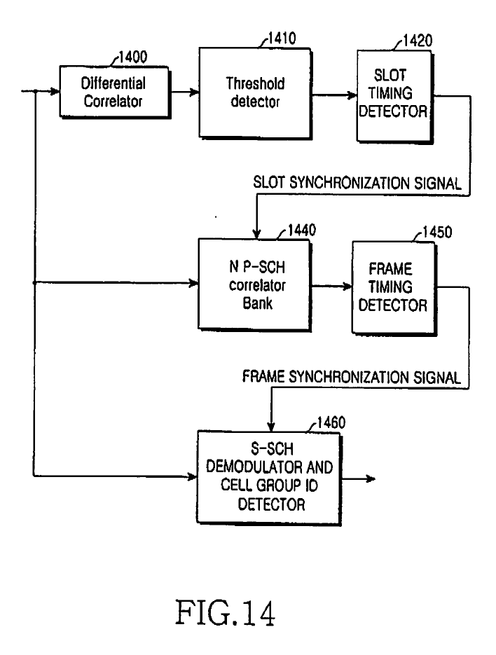

Referring to FIG. 14, a P-SCH codeword with N code symbols PC₀ to PC_{N-1} is transmitted in a frame with N sync slots. Each code symbol is transmitted at a predetermined timing in a sync slot. A code symbol PCₖ has repeated codes PSCₖ in time, as illustrated in FIG. 13. In the illustrated case of FIG. 14, a PSC occurs twice for a PC. In an OFDM system, the PSCs can be repeated so that the even-numbered or odd-numbered frequency components of the P-SCH are 0s.

In general, if a first component of a PC is PSCₖ, its second component is α*PSCₖ in which α is a phase variation between the PSCs. In the exemplary embodiment of the present invention, a is preset between the BS and the MS to facilitate timing detection.

Every BS transmits the common P-SCH codeword with the code symbols PC₀ to PC_{N-1OFB} in the manner illustrated in FIG. 8B. Each code symbol indicates the position of a slot where it is delivered in a frame.

In the MS, a received signal passes through a differential correlator 1400, is sampled and compared with a predetermined threshold in a threshold detector 1410. The output of differential correlator 1400 for each PSC is determined according to the repetition characteristics of the PSC irrespective of a codeword type. That is, even though a different codeword is transmitted on the P-SCH, differential correlator 1400 outputs a high value at slot timing. Slot timing can be acquired by a cell search only for one sync slot, starting at a given time point. The number of the samples of one sync slot are denoted by L. Threshold detector 1410 compares the outputs of differential correlator 1400 with the threshold and detects an output of differential correlator 1400 exceeding the threshold. A slot timing detector 1420 determines a timing corresponding to the detected output to be the slot timing. If there is no differential correlator output exceeding the threshold, the above operation is repeated for the L samples of another sync slot.

Slot timing detector 1420 notifies a P-SCH correlator bank 1440 with N P-SCH correlators of the slot timing by a slot synchronization signal. P-SCH correlator bank 1440 detects the positions of code symbols of the P-SCH in one frame using the slot timing.

Since every BS transmits the same codeword (PC₀, PC₁, . . . , PC_{N-1}), all possible codewords received at the MS are N codewords, (PC₀, PC₁, . . . , PC_{N}), (PC₁, PC₂, . . . , PC₀), . . . , (PC_{N-1}, PC₀, . . . , PC_{N-2}). P-SCH correlator bank 1440 correlates a codeword received at the detected positions with the N possible codewords. A frame timing detector 1450 selects a codeword with the highest correlation and acquires frame synchronization using the codeword. An S-SCH demodulator and cell group ID detector 1460 acquires a cell group ID by demodulating the S-SCH.

The MS illustrated in FIG. 14 is easily configured and requires neither an additional memory nor an accumulator. However, wrong slot/frame synchronization may be acquired or no synchronization may be acquired according to the threshold. Hence, setting an appropriate threshold is significant.

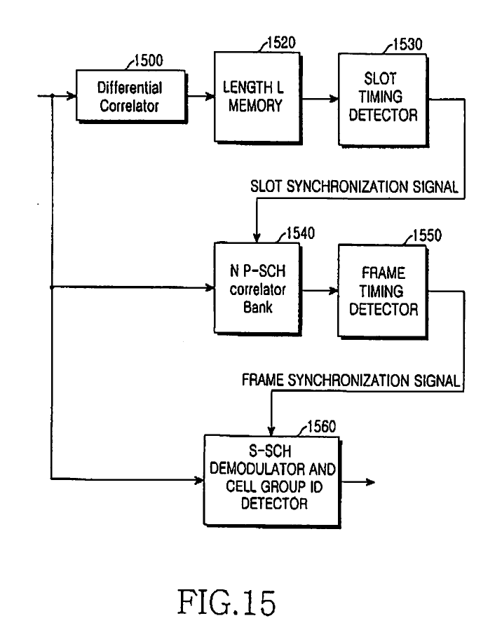

Referring to FIG. 15, a P-SCH codeword with N code symbols PC₀ to PC_{N-1} is transmitted in a frame with N sync slots. Each code symbol is transmitted at a predetermined timing in a sync slot. A code symbol PCₖ has repeated codes PSCₖ in time. In FIG. 15, a PSC occurs twice in a PC. In an OFDM system, the PSCs can be repeated so that the even-numbered or odd-numbered frequency components of the P-SCH are 0s.

In general, if a first component of a PC is PSCₖ, its second component is α*PSCₖ in which α is a phase variation between the PSCs. In the exemplary embodiment of the present invention, α is preset between the BS and the MS to facilitate timing detection.

Every BS transmits the common P-SCH codeword with the code symbols PC₀ to PC_{N-1OFB} in the manner illustrated in FIG. 8B. Each code symbol indicates the position of a slot where it is delivered in a frame.

In the MS, a received signal passes through a differential correlator 1500, is sampled and L samples of a sync slot length are stored in a memory 1520. The output of differential correlator 1500 for each PSC is determined according to the repetition characteristics of the PSC irrespective of a codeword type. That is, even though a different codeword is transmitted on the P-SCH, differential correlator 1500 outputs a high value at slot timing. Slot timing can be acquired by a cell search only for one sync slot, starting at a given time point. Therefore, a slot timing detector 1530 detects a memory index with a sample with the highest value among the L samples and determines the timing corresponding to the memory index to be slot timing. The cell search apparatus is simple to configure and requires no accumulator.

The slot timing detected by slot timing detector 1530 is notified to a P-SCH correlator bank 1540 with N P-SCH correlators by a slot synchronization signal. P-SCH correlator bank 1540 detects the positions of code symbols of the P-SCH in one frame using the slot timing. Since every BS transmits the same codeword (PC₀, PC₁, . . . , PC_{N-1}), all possible codewords received at the MS are N codewords, (PC₀, PC₁, . . . , PC_{N}), (PC₁, PC₂, . . . , PC₀), . . . , (PC_{N-1}, PC₀, . . . , PC_{N-2}).

The P-SCH correlator bank 1540 correlates a codeword received at the detected positions with the N possible codewords. A frame timing detector 1550 selects a codeword with the highest correlation and acquires frame synchronization using the codeword. An S-SCH demodulator and cell group ID detector 1560 acquires a cell group ID by demodulating the S-SCH.

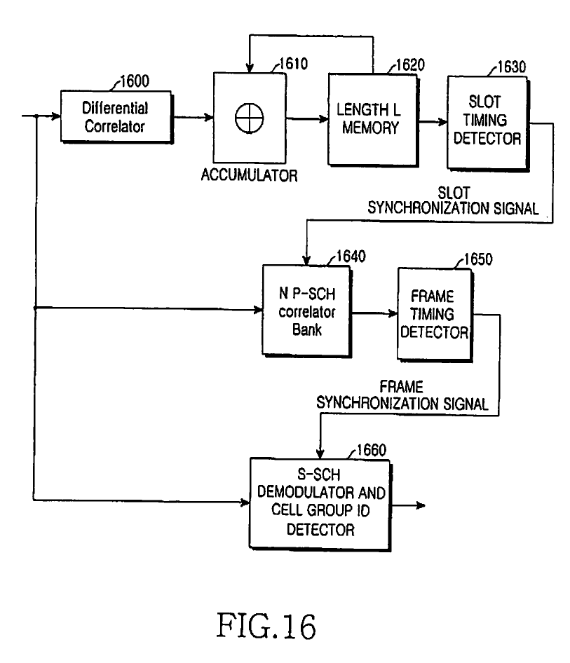

Referring to FIG. 16, a P-SCH codeword with N code symbols PC₀ to PC_{N-1} is transmitted in a frame with N sync slots. Each code symbol is transmitted at a predetermined timing in a time slot period. A code symbol PCₖ has repeated codes PSCₖ in time. In FIG. 16, a PSC occurs twice in a PC. In an OFDM system, the PSCs can be repeated so that the even-numbered or odd-numbered frequency components of the P-SCH are 0s.

In general, if a first component of a PC is PSCₖ, its second component is α*PSCₖ in which α is a phase variation between the PSCs. In the exemplary embodiment of the present invention, α is preset between the BS and the MS to facilitate timing detection.

Every BS transmits the common P-SCH codeword with the code symbols PC₀ to PC_{N-1OFB} in the manner illustrated in FIG. 8B. Each code symbol indicates the position of a slot where it is delivered in a frame.

In the MS, a received signal passes through a differential correlator 1600, is sampled and L samples of a sync slot length are stored in a memory 1620. The output of differential correlator 1600 for each PSC is determined according to the repetition characteristics of the PSC irrespective of a codeword type. That is, even though a different codeword is transmitted on the P-SCH, differential correlator 1600 outputs a high value at slot timing.

The MS can acquire slot timing and frame timing simultaneously by a cell search only for one sync slot, starting at a given time point. Correlations for one sync slot from differential correlator 1600 are sequentially stored in memory 1620. The number of the samples of one sync slot are denoted by L. Hence, the correlations of differential correlator 1600 for one sync slot form an array of length L. An element with a maximum value in the array represents the start of a slot within a window of a size equal to a sync slot.

However, considering channel status such as a fading channel, one sync slot does not suffice for detecting slot timing. Therefore, an accumulation of correlations for a plurality of sync slots is used. That is, accumulator 1610 accumulates the correlations for the sync slots and stores the accumulation values in memory 1620. Initial values in memory 1620 are set to 0s. Accumulator 1610 accumulates the correlations at the same phase.

Accumulator 1610 selects synchronous accumulation or asynchronous accumulation according to channel status. Accumulation of the outputs of differential correlator 1600 at an interval of a sync slot produces an array of size L. Asynchronous accumulation applies between sync slots. A slot timing detector 1630 selects an element with a maximum value in the vector and determines the timing of the element to be the start of a slot within a window of a size equal to a sync slot of the P-SCH. The slot timing detected by slot timing detector 1630 is notified to a P-SCH correlator bank 1640 with N P-SCH correlators by a slot synchronization signal. P-SCH correlator bank 1640 detects the positions of the code symbols of the P-SCH in one frame using the slot timing. Since every BS transmits the same codeword (PC₀, PC₁, . . . , PC_{N-1}), all possible codewords received at the MS are N codewords, (PC₀, PC₁, . . . , PC_{N}), (PC₁, PC₂, . . . PC₀), . . . , (PC_{N-1}, PC₀, . . . , PC_{N-2}).

P-SCH correlator bank 1640 correlates a codeword received at the detected positions with the N possible codewords. A frame timing detector 1650 selects a codeword with the highest correlation and acquires frame synchronization using the codeword. An S-SCH demodulator and cell group ID detector 1660 acquires a cell group ID by demodulating the S-SCH.

If the channel status does not allow for acquisition of frame synchronization from one sync slot of the P-SCH, frame synchronization is acquired by accumulating correlations for a plurality of sync slots. Accumulator 1610 accumulates the outputs of differential correlator 1600 for the sync slots synchronously or asynchronously. In FIG. 16, it is assumed that after the energy levels of the outputs of the differential correlator 1600 are calculated, accumulator 1610 performs asynchronous accumulation.

The elements W_{i,j} of the array of length L are expressed as Equation (2);

$${W}_{i , j} = {\sum }_{p = 0}^{M - 1} h ( p \cdot L + j - 1 ) , 1 \leq j \leq L \qquad ( 2 )$$

where L denotes the number of the samples output from the differential correlator for one sync slot, M denotes the number of sync slots for which correlations are accumulated, h(y) denotes an y^{th} sample of the differential correlator.

After the acquisition of slot synchronization and frame synchronization, frame timing detector 1650 provides a frame synchronization signal to the S-SCH demodulator and cell group ID detector 1660. The S-SCH demodulator and cell group ID detector 1660 detects the position of the S-SCH in the received signal using the frame synchronization signal. The position of the S-SCH is detected using a predetermined timing in the case of TDM and using a predetermined frequency band in the case of FDM. In the case of CDM, the S-SCH and the P-SCH are at the same position and an SC of the S-SCH is detected using a predetermined code. The S-SCH demodulator and cell group ID detector 1660 acquires a cell ID by decoding the S-SCH.

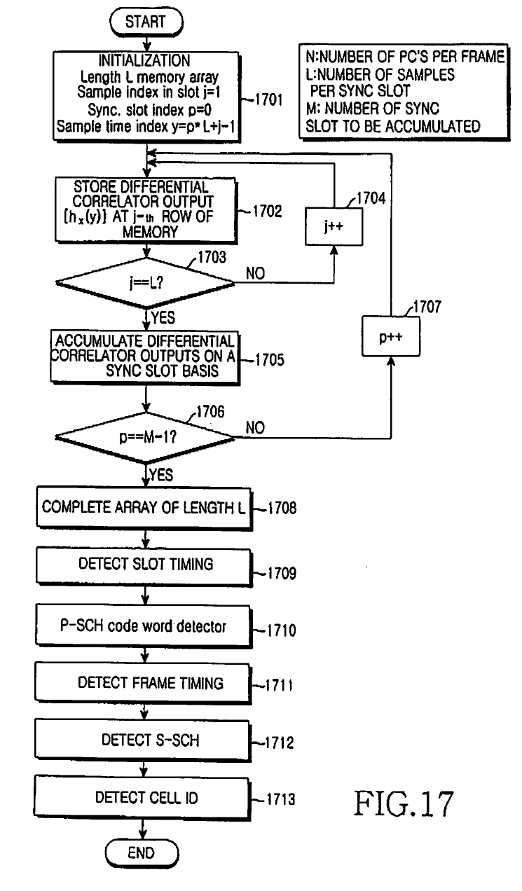

Referring to FIG. 17, an initial value is set in each block in step 1701 and the output of the differential correlator is stored in the memory in step 1702. In step 1703, the index j of a sample in the sync slot is compared with the number L of samples per sync slot. After sequentially increasing j up to L in step 1704, steps 1702 and 1703 are repeated.

If j is equal to L in step 1703, the outputs of the differential correlator are accumulated on a sync slot basis in step 1705 and then the index p of the sync slot is compared with the number M of sync slots to be accumulated in step 1706.

Until p is equal to (M−1), after increasing p sequentially in step 1707, steps 1702, 1703, and 1705 are repeated.

If p is equal to (M−1) in step 1706, an array of length L is completed in step 1708 and slot timing is detected in step 1709. A P-SCH codeword is detected in step 1710 and frame timing is detected in step 1711. The S-SCH is detected in step 1712 and a cell ID is detected in step 1713. Thus the cell search is finished.

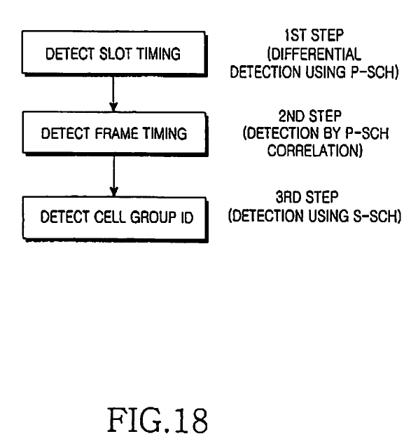

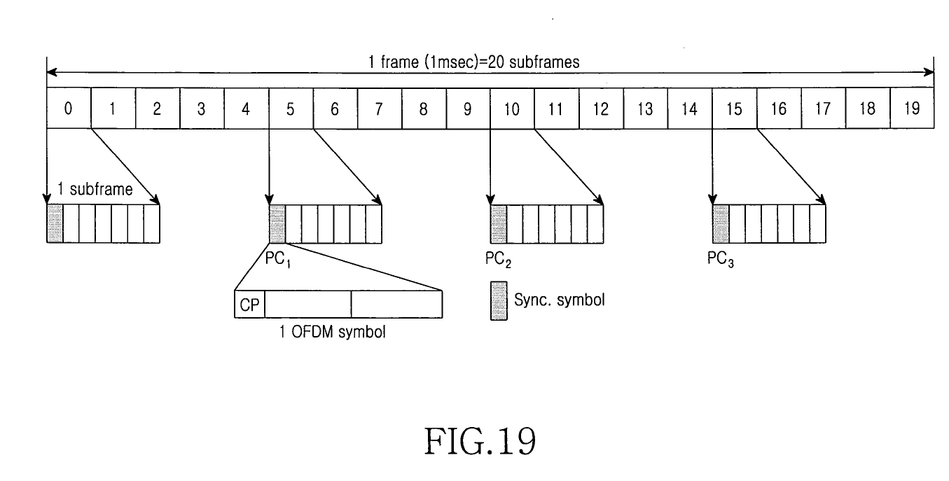

Referring to FIG. 18, in initial synchronization, slot timing is detected by differential detection based on the repetition characteristics of the P-SCH in a first step. To improve the performance of the differential detection, asynchronous accumulation can be carried out between sync slots. In a second step, frame timing is detected using the slot timing. Compared to a WCDMA system in which frame synchronization is acquired using the S-SCH, frame synchronization is acquired using a P-SCH codeword in the present invention. Then system information including a cell group ID is acquired by demodulating the S-SCH.

In 3GPP LTE, OFDMA is used for the downlink. One radio frame is composed of 20 subframes, each having 7 OFDM symbols. The radio frame includes four sync OFDM symbols, each carrying a PC of a P-SCH. The four OFDM symbols are the first OFDM symbols of subframes #0, #5, #10 and #15. The four OFDM symbols are different PCs, common to all BSs. If a PC is formed in an OFDM symbol, data symbols are positioned on even-numbered subcarriers and off-numbered subcarriers are masked, thus easily producing a repetition pattern in time as illustrated in FIG. 13. In this case, a receiver is configured as illustrated in FIG. 14, FIG. 15 or FIG. 16.

In accordance with the present invention as described above, slot timing and frame timing are acquired only if a P-SCH and a cell ID are detected using an S-SCH. As a predetermined number of code symbols for a P-SCH codeword are defined, codewords are achieved for comparison to acquire the frame synchronization.

In WCDMA, frame timing is acquired using the S-SCH by searching 64 cell IDs, with a large computation volume. After a cell group ID is detected, one of eight possible cell IDs is estimated using a common pilot channel to acquire the ID of a cell.

In the present invention, however, a cell ID is transmitted on an S-SCH. Cell information is repeated or encoded with an error correction code, for safe transmission on the S-SCH. Therefore, there is no need for demodulating the S-SCH in every slot, and time taken in relation to the S-SCH can be variably controlled according to channel status.

While the invention has been shown and described with reference to certain exemplary embodiments thereof, it will be understood by those skilled in the art that various changes in form and details may be made therein without departing from the spirit and scope of the present invention as further defined by the appended claims and their equivalents.

What is claimed is:

1. A method for performing a cell search using a primary synchronization channel (P-SCH) and a secondary synchronization channel (S-SCH) received from a Base Station (BS) in a Mobile Station (MS), comprising:
receiving a P-SCH signal including at least two different P-SCH synchronization codes in different slots of a frame;
detecting slot timing and frame timing using the P-SCH signal; and
identifying the cell.

2. The method of claim 1, wherein the detection comprises:
determining a position of at least one detected P-SCH synchronization code during a sync slot to be the slot timing, the sync slot being an interval between two adjacent P-SCH synchronization codes; and
detecting the frame timing using a P-SCH synchronization code sequence estimated from the at least one detected P-SCH synchronization code.

3. The method of claim 1, wherein the P-SCH synchronization codes are orthogonal codes.

4. The method of claim 1, further comprising:
receiving an S-SCH signal including at least two different S-SCH synchronization codes in different slots of a frame; and
detecting at least one of an identification (ID) of a cell to which the MS belongs and a group ID of the cell using the S-SCH signal.

5. The method of claim 4, wherein one of the at least two P-SCH synchronization codes carries information required for detection of at least one of the slot timing and the frame timing.

6. The method of claim 4, wherein information required for detection of at least one of the cell ID and the cell group ID is distributed to the at least two S-SCH synchronization codes.

7. The method of claim 4, wherein information required for detection of at least one of the cell ID and the cell group ID is repeated in the at least two S-SCH synchronization codes.

8. The method of claim 4, wherein the S-SCH signal reception comprises receiving the S-SCH signal in a different slot from the P-SCH signal.

9. The method of claim 4, wherein the at least two S-SCH synchronization codes are orthogonal codes different from the at least two P-SCH synchronization codes.

10. The method of claim 4, wherein the S-SCH signal reception comprises receiving the S-SCH signal in a different frequency area from the P-SCH signal.

11. An apparatus for performing a cell search using a primary synchronization channel (P-SCH) and a secondary synchronization channel (S-SCH) received from a Base Station (BS) in a Mobile Station (MS), comprising:
an SCH receiver for receiving a P-SCH signal including at least two different P-SCH synchronization codes in different slots of a frame; and
a synchronization detector for detecting slot timing and frame timing using the P-SCH signal.

12. The apparatus of claim 11, wherein the SCH receiver comprises:
a matched filter bank including a plurality of matched filters corresponding to respective P-SCH synchronization codes of the P-SCH; and
a threshold detector for comparing outputs of the matched filters with a predetermined threshold,
wherein the synchronization detector detects the slot timing and the frame timing using an output of the threshold detector.

13. The apparatus of claim 11, wherein the SCH receiver comprises:
a matched filter bank including a plurality of matched filters corresponding to respective P-SCH synchronization codes of the P-SCH; and
a memory for sampling outputs of the matched filters and storing the samples in the form of a matrix,
wherein the synchronization detector detects an element with a maximum value in the matrix and detects the slot timing and the frame timing using the detected element.

14. The apparatus of claim 11, wherein the SCH receiver comprises:
a matched filter bank including a plurality of matched filters corresponding to respective P-SCH synchronization codes of the P-SCH; and
an accumulation controller for outputting a control signal to accumulate outputs of the matched filters;
an accumulator for sampling outputs of the matched filters and accumulating the sampled values according to the control signal; and
a memory for storing outputs of the accumulator in the form of a matrix according to the control signal,
wherein the synchronization detector detects an element with a maximum value in the matrix and detects the slot timing and the frame timing using the detected element.

15. The apparatus of claim 11, wherein each of the at least two different P-SCH synchronization codes includes repeated codes, wherein the SCH receiver comprises:
a correlator for receiving the S-SCH signal and outputting correlations of the S-SCH signal; and
a threshold detector for comparing the correlations with a predetermined threshold,
wherein the synchronization detector comprises:
a slot timing detector for detecting the slot timing using an output of the threshold detector;
a correlator bank for determining the positions of P-SCH synchronization codes of the P-SCH in a frame using the slot timing, correlating a codeword received at the detected positions with possible codewords, and outputting correlations; and
a frame timing detector for detecting the frame timing using a highest correlation from among the correlations received from the correlator bank.

16. The apparatus of claim 11, wherein each of the at least two different P-SCH synchronization codes include repeated codes, wherein the SCH receiver comprises:
a correlator for receiving the S-SCH signal and outputting correlations of the S-SCH signal;
a memory for sampling the correlations received from the correlator and storing the samples in the form of a matrix;
a slot timing detector for detecting the slot timing using an element with a maximum value in the matrix;
wherein the synchronization detector comprises:
a correlator bank for determining the positions of P-SCH synchronization codes of the P-SCH in a frame using the slot timing, correlating a codeword received at the detected positions with possible codewords, and outputting correlations; and
a frame timing detector for detecting the frame timing using a highest correlation from among the correlations received from the correlator bank.

17. The apparatus of claim 11, wherein each of the at least two different P-SCH synchronization codes includes repeated codes, wherein the SCH receiver comprises:
a correlator for receiving the S-SCH signal and outputting correlations of the S-SCH signal; and
a memory for sampling the correlations received from the correlator and accumulating the samples in the form of a matrix,
wherein the synchronization detector comprises:
a slot timing detector for detecting the slot timing using a sample with a maximum value;
a correlator bank for determining the positions of P-SCH synchronization codes of the P-SCH in a frame using the slot timing, correlating a codeword received at the detected positions with possible codewords, and outputting correlations; and
a frame timing detector for detecting the frame timing using a highest correlation from among the correlations received from the correlator bank.

18. The apparatus of claim 11, wherein the SCH receiver further receives an S-SCH signal including at least two different S-SCH synchronization codes in different slots of a frame, and the synchronization detector includes a cell identification (ID) detector for detecting at least one of an identification (ID) of a cell to which the MS belongs and a group ID of the cell using the S-SCH signal.

19. The apparatus of claim 18, wherein the SCH receiver receives the S-SCH signal in a different slot form the P-SCH signal.

20. The apparatus of claim 18, wherein the at least two S-SCH synchronization codes are orthogonal codes different from the at least two P-SCH synchronization codes.

21. The apparatus of claim 18, wherein the SCH receiver receives the S-SCH signal in a different frequency area from the P-SCH signal.
